(19) United States
(12) Patent Application Publication
(10) Pub. No.: US 2014/0068765 A1
(43) Pub. Date: Mar. 6, 2014

(54) METHOD AND APPARATUS FOR AUTHENTICATING USER IN MULTIPARTY QUANTUM COMMUNICATIONS

(71) Applicants: Jeong-Woon CHOI, Daejeon (KR); Ku-Young CHANG, Daejeon (KR); Tae-Gon NOH, Daejeon (KR); Dong-Pyo CHI, Seoul (KR); Soo-Joon LEE, Seoul (KR)

(72) Inventors: Jeong-Woon CHOI, Daejeon (KR); Ku-Young CHANG, Daejeon (KR); Tae-Gon NOH, Daejeon (KR); Dong-Pyo CHI, Seoul (KR); Soo-Joon LEE, Seoul (KR)

(73) Assignee: Electronics and Telecommunications Research Institute, Daejeon-city (KR)

(21) Appl. No.: 12/971,853

(22) Filed: Dec. 17, 2010

(30) Foreign Application Priority Data
Dec. 18, 2009 (KR) 10-2009-0126701
Apr. 12, 2010 (KR) 10-2010-0033400

(51) Int. Cl. H04L 29/06

(52) U.S. Cl. CPC H04L 63/1416
USPC 726/23

(57) ABSTRACT

the present invention provides a method for authenticating a user in a multiparty quantum communication comprising: generating l quantum entangled states with N particles and transmitting each particle of the l quantum entangled states to N users, by a quantum communication server, wherein the N is a natural number larger than 2; determining, by the quantum communication server, whether a disguised attacker exists among N users on the basis of a first error rate calculated by using n quantum states randomly selected from the l quantum states possessed by the users respectively and a previously shared secret key in each of the users; and controlling, by the quantum communication server, each of the users to generate a new secret key using mₖ quantum states and replace the previously shared secret key with the new secret key.

### CROSS REFERENCE TO RELATED APPLICATION

This application claims the benefit of Korean Patent Application No. 10-2009-0126701, filed on Dec. 18, 2009 and Korean Patent Application No. 10-2010-0033400, filed on Apr. 12, 2010, which are hereby incorporated by reference in its entirety into this application.

### BACKGROUND OF THE INVENTION

1. Field of the Invention

The present invention relates to a quantum key distribution technology capable of implementing safe cryptographic communication by allocating attributes of photons to data. More particularly, the present invention relates to a technology that accurately authenticates a user and handles an error which occurs on a channel by transmitting an N-partite Greenberger-Horne-Zeilinger (GHZ) state which is applicable to quantum communication and cryptographic protocols and verifies whether or not the N-partite GHZ state transmitted through a quantum channel is distributed to a legitimate user having a secret key transmitted to said user in advance.

2. Description of the Related Art

Encryption of information is a core technology for prevention of illegal technologies such as hacking, and the like. The encryption of information is a technology that enables only a legitimate user to use the information while authenticating the legitimate user by encrypting used information and reconfiguring the information by using an encryption key. The performance of an encryption system is determined by an encryption strength representing the defense rate against an attacker who wants to find a key or information. That is, the higher the encryption strength is, the higher the security of the encryption system. Therefore, a research of the encryption system for increasing the encryption strength is widely progressing.

The most safe and latest cryptographic communication technology is a quantum key distribution protocol. The quantum key distribution protocol requires authentication of a user in order to ensure the security against a man-in-the-middle attack of intercepting secret keys exchanged among users. The most representative authentication method used in performing the quantum key distribution protocol ensures an unconditional security by combining a classic authentication method and the quantum key distribution with each other.

However, an authentication method using only a quantum property without applying the classic encryption method is not provided and in addition, in a multiparty quantum cryptographic communication protocol other than the quantum key distribution protocol, an authentication method has not yet been researched.

### SUMMARY OF THE INVENTION

An object of the present invention is to provide a quantum authentication method capable of authenticating the legitimate users in multiparty quantum communication and cryptographic protocols without depending on a classic encryption method. In particular, the object of the present invention is to provide a technology that can extract an N-partite GHZ (a relation in which N particles are quantum-entangled with each other) state without limitation in the number of users, perform a user authentication procedure, and generate and share a new secret key for the next authentication, even when a portion of errors are occurred by the quantum decoherence with environment during quantum transmission and detection,

An embodiment of the present invention provides a method for authenticating a user in a multiparty quantum communication that comprises: generating l quantum entangled states with N particles and transmitting each particle of the l quantum entangled states to N users, by a quantum communication server, wherein the N is a natural number larger than 2; determining, by the quantum communication server, whether a disguised attacker exists among N users on the basis of a first error rate calculated by using n quantum states randomly selected from the l quantum states possessed by the users respectively and a previously shared secret key in each of the users; and controlling, by the quantum communication server, each of the users to generate a new secret key using mₖ quantum states and replace the previously shared secret key with the new secret key.

The determining calculates the first error rate by analyzing a parity relation between measurement axes and measurement values acquired by measuring n quantum states of particles possessed by each of the users respectively on the basis of the previously shared secret key.

The measurement axes are determined as any one of an X axis and a Y axis depending on bit information of the previously shared secret key in the order of the quantum states to be measured.

The determining abolishes a present quantum protocol by determining that the disguised attacker exists when the first error rate is larger than a threshold value of the first error rate.

The first error rate is computed by selecting any one of an even parity relation and an odd parity relation depending on the number of the measurements measured with Y axis of each of the n quantum states, determining whether or not the parity relation selected is satisfied for each of the users, and using the determination result.

The method for authenticating the user in the multiparty quantum communication may further comprise computing, by the quantum communication server, a second error rate related to whether or not measurement axes and measurement values acquired by measuring m quantum states of particles randomly selected from the l quantum states of particles satisfy a parity relation.

The second error rate is computed by selecting any one of even parity relation and the odd parity relation depending on the number of the measurements measured with Y axis of each of the m quantum states, determining whether or not the parity relation selected is satisfied for each of the users, and using the determination result.

The controlling may comprise: controlling, by the quantum communication server, each of the users to generate a new secret key; and controlling, by the quantum communication server, each of the users to replace the previously stored secret key with the new secret key.

The mₖ is equal to or less than the rest number acquired by subtracting n and m from l and equal to or more than the number of the particles included in the previously stored secret key.

The controlling each of the users to generate controls each of the users to change a measurement value of a quantum state among the mₖ quantum states so that the parity relation of the mₖ quantum states is the even parity relation.

The controlling each of the users to generate controls each of the users to divide bit string which is corresponding to mₖ quantum states into a plurality of blocks and generate bit string of the new secret key which has the length shortened to as many as the number of bits leaked during an error correction and h of bits relating to privacy amplification.

The controlling each of the users to replace controls each of users to select an amount of bits required for the next authentication from the new secret key and replace the secret key previously stored.

The method for authenticating the user in the multiparty quantum communication further comprising purifing the error, by the quantum communication server, which occurs during the communications between users, of less than rest of the quantum states acquired by subtracting n, mₖ, and the m quantum states from the l quantum states.

An apparatus for authenticating a user in a multiparty quantum communication, comprising: a user authenticator generating l quantum entangled states with N particles and determines whether or not a disguised attacker exists among the N users, wherein the N is a natural number larger than 2; an error rate calculator calculating a first error rate by using n quantum states randomly selected from the l quantum states possessed by the users respectively and a previously shared secret key and providing the first error rate to the user authenticator in order to determine whether the disguised attacker exists; and a secret key generation controller controlling each of the users to generate a new secret key using mₖ quantum states randomly selected from the l quantum states.

The error rate calculator calculates the first error rate by analyzing the parity relation between measurement axes and measurement values acquired by measuring n quantum states of particles possessed by the users respectively on the basis of the previously shared secret key.

The error rate calculator may further comprise a function of computing a second error rate related to whether or not measurement axes and measurement values acquired by measuring m quantum states of particles randomly selected from the l quantum states of particles satisfy a parity relation.

The mₖ is equal to or less than the rest number acquired by subtracting the n and the m from the l and equal to or more than the number of particles included in the previously stored secret key.

The secret key generation controller comprise a function of controlling each of the user to change a measurement value of a quantum state among the mₖ quantum states so that the parity relation of the mₖ quantum states is the even parity relation.

The secret key generation controller controls each of the users divide bit string which is corresponding to mₖ quantum states into a plurality of blocks and generate bit string of the new secret key which has the length shortened to as many as the number of bits leaked during an error correction and h of bits relating to privacy amplification.

The apparatus for authenticating the user in the multiparty quantum communication further comprising a quantum distiller purifying an error, which occurs during the communications between users, of less than rest of the quantum states acquired by subtracting n, mₖ, and the m quantum states from the l quantum states.

According to the exemplary embodiments of the present invention, it is possible to authenticate a user on quantum communication without depending on a classic authentication method. Further, since a quantum entangled state is analyzed without limitation in the number of users and a new secret key is generated, it is possible to ensure the unconditional safety against an attack from a disguised attacker without information on the secret key. In addition, even though an error in states of quantum particles which occurs due to a disguised attacker or a transmission error occurs, the error can be cleaned through a post-processing protocol, and a new quantum entangled state is extracted and linked with various actual quantum communication technologies.

### BRIEF DESCRIPTION OF THE DRAWINGS

FIG. 1 is a flowchart of a method for authenticating a user in a multiparty quantum communication according to an embodiment of the present invention;

FIGS. 2 to 4 are flowcharts, in more detail, of a method for authenticating a user in the multiparty quantum communication according to an embodiment of the present invention; and

FIG. 5 is a block diagram of an apparatus for authenticating a user in a multiparty quantum communication according to an embodiment of the present invention.

### DETAILED DESCRIPTION OF THE PREFERRED EMBODIMENTS

Hereinafter, a method and an apparatus for authenticating a user in a multiparty quantum communication according to an embodiment of the present invention will be described with reference to the accompanying drawings.

It is to be understood that the invention is not limited to the disclosed embodiments, but, on the contrary, is intended to cover various modifications and equivalent arrangements included within the spirit and scope of the appended claims.

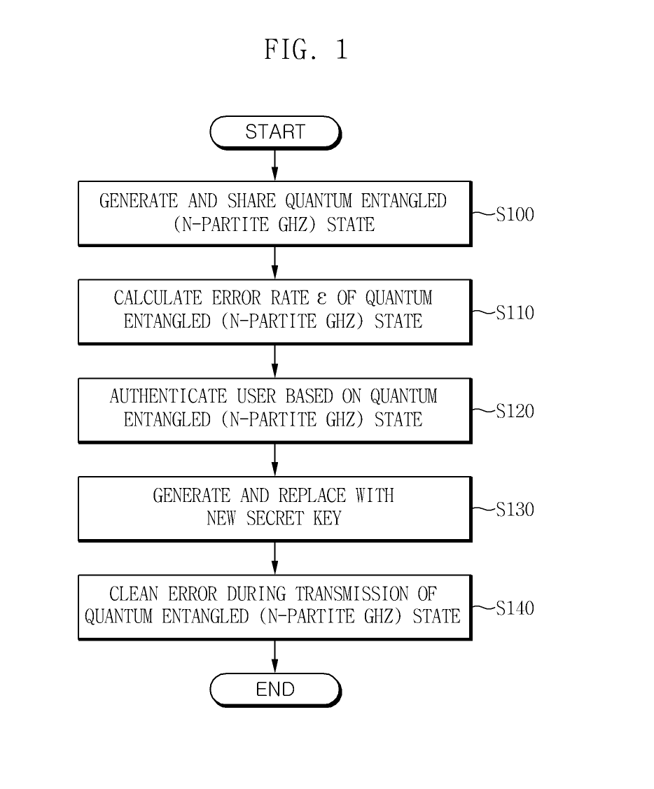

FIG. 1 is a flowchart of a method for authenticating a user in a multiparty quantum communication according to an embodiment of the present invention.

In FIGS. 1 to 5, an N-partite GHZ (Greenberger-Horne-Zeilinger) state means a state applicable to various quantum communication and cryptographic protocols such as quantum teleportation, quantum dense coding, quantum key distribution, quantum entanglement swapping, quantum secret sharing, and the like. The N-partite GHZ state is a well-known quantum multipartite state in which particles are quantum-entangled with each other. Hereinafter, the N-partite GHZ state and the quantum entangled state or an entangled state are used as the same meaning.

Further, in the description hereinafter of the embodiment of the present invention, an action in which N users select and measure particles that exist in the quantum entangled state possessed by the users means that N users individually performs the actions in accordance with a command from a quantum communication server.

Referring to FIG. 1, the method for authenticating a user in a multiparty quantum communication according to the embodiment of the present invention comprises allowing one user among N (N is a natural number larger than 2) users to generate l quantum entangled states, which each are constituted by N particles and transmit l particles corresponding to the users to the users (S100); allowing a quantum communication server to determine whether or not a disguised attacker exists among N users on the basis of first error rate computed by using n particles randomly selected from the particles possessed by the users respectively and a secret key previously stored (S120); and allowing the quantum communication server to control the user to generate a new secret key using mₖ particles randomly selected from the particles and replace the previously stored secret key with the new secret key (S130).

Additionally, the method further comprises allowing the quantum communication server to compute second error rate as to whether a measurement axis and a measurement value acquired by measuring quantum states of m particles randomly selected from the l particles satisfy a parity relation (S110) and allowing the quantum communication server to clean an error, which occurs while transmitting quantum states of particles of a number acquired by subtracting the n to the m from the first number (S140).

The method for authenticating a user in a multiparty quantum communication according to the embodiment of the present invention performs a following protocol except for undetected parts due to a loss in the quantum channel and imperfect device such as photon detector and quantum memory. Further, the users share secret keys K⁽ⁱ⁾=(K₁⁽ⁱ⁾, K₂⁽ⁱ⁾, . . . , Kₙ⁽ⁱ⁾) before performing the protocol and j-th bits among particles (alternately, bits) included in each secret key satisfy

$${\sum }_{i = 1}^{N} {k}_{j}^{( i )} ≡ 0 ( mod 2 ) .$$

At step S100, the quantum communication server generates the l quantum entangled states (N-partite GHZ state) (i.e., 2m) and thereafter, transmits N particles included in each quantum entangled state to the user one by one. As a result, N users share 2m quantum states of particles and each of 2m particles has the quantum entangled state relation with particles of other users.

In the embodiment of the present invention, the quantum communication server performs step S100, but one of N users may perform the step. In this case, at step S100, the quantum communication server will be able to generate a command to allow any one of N users to generate the l quantum entangled states and possess one of N particles included in each quantum entangled state and transmit the rest N−1 particles to the rest of a plurality of users one by one, and transmit the command to the one user.

Determining whether or not the disguised attacker exists (S120) is a step at which the quantum communication server determines whether the disguised attacker is included in N users on the basis of the first error rate computed by using n particles randomly selected from the particles possessed by the users and a previously stored secret key.

In the embodiment of the present invention, step S120 may include computing the first error rate by checking a parity relation between a measurement axis and a measurement value acquired by measuring quantum states of the n particles possessed by the users on the basis of the previously stored secret key.

The parity relation is used to determine whether or not a sum of measurement values is odd or even.

The measurement value for the quantum state has the same meaning as a bit value in general data communication having 0 or 1 depending on the quantum states of the particles.

At step S120, a first error rate is computed by using n quantum states of particles randomly selected from the l particles (for example, l=2m) and the previously shared secret key.

More specifically, the selected quantum states of particles are measured depending on the previously shared secret key at step S120. The measurement axis measuring the j-th quantum state is determined as the X axis when kⱼ⁽ⁱ⁾=0 and as the Y axis when kⱼ⁽ⁱ⁾=1 in the corresponding order.

Each of the users authenticates whether or not N users possess the previously shared secret key at the same time by opening the measurement value and the measurement axis acquired by measuring the quantum states of the particles in accordance with the rule.

Specifically, N users present the first measurement value in the order of A₁, A₂, . . . , A_{N} and present all measurement values of the n in sequence while changing the order of announcement like A₂, A₃, . . . , A_{N}, A₁. Thereafter, they present the measurement axes in the reverse order of the announcement of measurement values, that is, first in order of A_{N}, A_{N-1}, . . . , A₁ and then A₁, A_{N}, . . . , A₃, A₂.

The quantum communication server receives information of the measurement values and the measurement axes that are presented by each of the users. Thereafter, when the measurements with Y axis of each of the n quantum states with respect to each bitstream is 0 (mod 4, that is, a remainder of division of the number of the measurements with Y axis by 4 is 0), the quantum communication server verifies whether or not a measurement value corresponding thereto has an even parity relation and when the number is 2 (mod 4), the quantum communication server checks an odd parity relation. According to the check result, a ratio unsatisfying the even or odd parity relation is measured as the first error rate (ε_{UA}).

The first error rate means not an error rate for equality relation but an error rate for the parity relation as described above.

When the disguised attacker exists, since the disguised attacker does not possess the previously stored secret key, a probability that the parity relation will not be satisfied is very high. As a result, the computed value of the first error rate cannot but be high.

Accordingly, if the computed first error rate is larger than a first error threshold value (ε_{c}), it is determined that the disguised attacker exists and a current quantum protocol is abolished. In this case, quantum communication is controlled based on a new quantum protocol.

In the embodiment of the present invention, a threshold value of the first error rate is an important reference to determine whether or not the disguised attacker exists. In order to decide the threshold reasonably, it is very necessary to consider the error rate occurred by erroneous environment, not by an attacker. Note that there is always 3%˜10% erroneous results even in quantum key distribution system.

The method for authenticating a user in a multiparty quantum communication according to the embodiment of the present invention may further comprise allowing the quantum communication server to compute the second error rate as to whether or not the measurement axis and the measurement value acquired by measuring quantum states of m particles randomly selected from the/particles satisfy the parity relation (S110).

The second error rate is computed by determining whether or not users' measurement values for each of the chosen m quantum states have the right parity relation corresponding to the number of measurement with Y axis. If the second error rate is larger than a threshold value of second error rate, the current quantum protocol is abolished and a new quantum protocol will be able to be used.

More concretely, each of the users randomly selects quantum entangled states (quantum states) of the fourth number (m) randomly selected from the l quantum states by the command from the quantum communication server. Thereafter, measurement for the X axis or the Y axis is randomly performed.

Then, each of N users opens the measurement value and the measurement axis. In general, each of N users use Y-axis measurement even-number of times for about m/2 quantum entangled states and only in this case, the parity relation of the measurement value may be verified. Through such a process, error rate which may occur during the transmission of the quantum communication, i.e., the second error rate (ε) will be calculated. For example, a quantum entangled state if N=3 may be shown as follows:

$$\begin{matrix} [ Equation 1 ] & \\ \begin{matrix}\frac{1}{\sqrt{2}} ( \vert 000 〉 + \vert 111 〉 ) = \frac{1}{2} ( {\vert 000 〉}_{XXX} + {\vert 011 〉}_{XXX} + {\vert 101 〉}_{XXX} + {\vert 110 〉}_{XXX} ) \\ = \frac{1}{2} ( {\vert 001 〉}_{XYY} + {\vert 010 〉}_{XYY} + {\vert 100 〉}_{XYY} + {\vert 111 〉}_{XYY} ) \\ = \frac{1}{2} ( {\vert 001 〉}_{YXY} + {\vert 010 〉}_{YXY} + {\vert 100 〉}_{YXY} + {\vert 111 〉}_{YXY} ) \\ = \frac{1}{2} ( {\vert 001 〉}_{YYX} + {\vert 010 〉}_{YYX} + {\vert 100 〉}_{YYX} + {\vert 111 〉}_{YYX} )\end{matrix} & \end{matrix}$$

Therefore, in the case in which all of three users performs X-axis measurement, the measurement value has the even parity relation and in the case in which among three users, one user performs X-axis measurement and the other two users performs Y-axis measurement, the measurement value has the odd parity relation.

In a general case of N quantum entangled states, when the number of users who perform Y-axis measurement is 0 (mod 4), the measurement value has the even parity relation and when the number of users who perform Y-axis measurement is 2 (mod 4), the measurement value has the odd parity relation. Accordingly, the error rate which occurs during the transmission of the quantum communication, i.e., the second error rate (ε) may be calculated by calculating a ratio not to satisfy the above-mentioned parity relation.

As described in the first error rate, the second error rate means the error rate as to whether to satisfy the parity relation, not error rate for an equality relation.

Meanwhile, step S110 is executed before step S120. Therefore, n is smaller than a number acquired by subtracting the m from the l when step S110 is executed.

When the second error rate is computed, the threshold value for the first error rate is determined in detail as follows. Assuming that first, K (0 to N−1) disguised attackers exists among N (N is a natural number larger than 2) users and no error occurs during the transmission of the quantum entangled state before the first error threshold value is determined, a probability P₀(N, K) that the disguised attacker will pass step S120 without damaging the parity relation between the measurement value and the measurement axis, by performing an optimized attack is as follows.

Considering the cases: a case in which the legitimate users present the measurement value at the first time and the last time, a case in which the disguised attacker presents the measurement value at the first time and the legitimate users present the measurement value at the last time, a case in which the legitimate users present the measurement value the first time and the disguised attacker presents the measurement value at the last time, and a case in which the disguised attacker presents the measurement value at the first time and the last time, P₀(N, K) is:

$${P}_{0} ( N , K ) \leq \frac{{N}^{3} - 3 {N}^{2} + N ( 2 {K}^{2} - 2 K + 2 ) - {K}^{3} - {K}^{2} + 2 K}{2 N ( N - 1 ) ( N - 2 )} \qquad [ Equation 2 ]$$

In particular, if K≦N/2, P₀(N, K)≦11/16.

Assuming the more practical situation the generates the error with the error rate ε acquired at step S110, a expected error rate P_{ε}(N, K) of error rate which may occur when the disguised attacker performs the optimized attack is:

P_{ε}(N,K):=εP₀(N,K)+(1−ε)(1−P₀(N,K))=1−P₀(N,K)+ε(2P₀(N,K)−1) [Equation 3]

As a result, a method to decide the threshold value ε_{c} will be described.

Letting X as a variable for the error rate in the case in which no disguised attacker, X is given by a normal distribution

$$N ( ɛ , \frac{ɛ ( 1 - ɛ )}{n} ) .$$

Similarly, if X′ is the variable for the error rate in the case in which the disguised attacker is included, then X′ is given by a normal distribution

$$N ( {P}_{c} ( N , K ) , \frac{{P}_{c} ( N , K ) ( 1 - {P}_{c} ( N , K ) )}{n} ) .$$

When the length of bit string of the secret key is given by n, ε_{c} should be selected to satisfy Equation 4 and 5 within the range of ε<ε_{c}<P_{ε}(N, K). Equation 4 ensures that the probability to fail in verifying the absence of attackers is smaller than 10⁻³⁰ and Equation 5 ensures that the probability to fail in showing the existence of attackers is smaller than 10⁻³⁰.

$$\begin{matrix} p ( \vert X - ɛ \vert > {ɛ}_{c} ) \leq {e}^{- \frac{{n ( {ɛ}_{c} - ɛ )}^{2}}{ɛ ( 1 - ɛ )}} < {10}^{- 30} & [ Equation 4 ] \\ \frac{1}{2} p ( \vert {X}^{′} - {P}_{ɛ} ( N , K ) \vert > {ɛ}_{c} ) \leq \frac{1}{2} {e}^{- \frac{{n ( {ɛ}_{c} - {P}_{ɛ} ( N , K ) )}^{2}}{{P}_{ɛ} ( N , K ) ( 1 - {P}_{ɛ} ( N , K ) )}} < {10}^{- 30} & [ Equation 5 ]\end{matrix}$$

When ε_{c} is acquired through the above method, a probability to succeed in authentication is substantially close to 1 in the case in which all of N users are the authenticated users and in the case in which the disguised attacker is provided, the existence of the disguised attacker may be verified with the probability which is substantially close to 1. For example, consider the case that the error rate for the parity relation and the number of disguised attacker are restricted to ε=0.1 and K≦N/2, respectively. Since P₀(N, K)≈11/16 and thus P_{c} (N, K)≈0.35, if we let the threshold value of the second error rate ε_{c}=0.19685 (0.1<ε_{c}<0.35) and the length of bit string of the secret key n=670, then the following equation can be acquired:

p(|X−ε|>ε_{c})≈½p(|X′−P_{ε}(N,K)|>ε_{c})<10⁻³⁰ [Equation 6]

The key replacement (S130) may comprise allowing the quantum communication server to control each of the users to generate a new secret key and allowing the quantum communication server to replace the previously stored secret key with the new secret key.

In the embodiment of the present invention, the mₖ is equal to or smaller than the rest number acquired by subtracting the n and the m from the l and equal to or larger than the number of particles included in the previously stored secret key. That is, the mₖ is smaller than m−n and larger than n̅, when the length of a secret key acquired through post-processing is n̅.

The controlling of the generation of the new secret key may change a measurement value of any one particle so that all the mₖ quantum states always satisfy the even parity relation, because the parity relation may be checked only when the user uses Y-axis measurement even number of times. Therefore, in order to generate the secret key having the even parity relation, when the number of users who perform Y-axis measurement is 2 (mod 4), any one of them flips his/her measurement value to change the odd parity relation into the eve parity relation (for example, when the measurement value is 0, 0 is changed into 1 and when the measurement value is 1, 1 is changed into 0).

In addition, the controlling of the generation of the new secret key may include a series of post-processing to provide legitimate users with new key strings, each bit of which satisfies the even parity relation by removing all error bits. More specifically, the users divide their bit strings, which are expected to have the even parity relation excepting for a small portion of errors occurred with ε, into a plurality of blocks of an adequate size predetermined by error rate e, find and correct errors by publicly comparing the parities of their blocks, and then amplify the privacy of the key string to be finally shared.

Since the controlling of the generation of the new secret key generates the news secret key, the measurement values should not be opened. After the parity bit is opened, each one bit is removed in order to maintain the uncertainty about the key string, that is, to prevent leaking additional information about the key string. If the sum of the parity bits for the plurality of blocks is the odd number, the blocks are divided into halves and parity bits for the divided blocks are checked until a location where the error occurs is found. If the location where the error occurs is found, the bit value of any one of N users is changed with respect to the location where the error occurs.

The above process is repeatedly performed until all errors are corrected, and finally generates the new secret key K̅⁽ⁱ⁾=( k̅₁⁽ⁱ⁾, k̅₂⁽ⁱ⁾, . . . , k̅ₙ⁽ⁱ⁾). As described above, in order to correct errors the parity bits (alternatively, information) are continuously opened and removed and this means the length of the new secret key should be shortened as many as the revealed bits.

Further, in order to amplify the privacy of the new secret key, that is, get rid of even any partial information about the new secret key, the specific h bits of information will be additionally excluded from the reconciled key string through universal hashing based on Toeplitz matrix. Of course, the number of bits of the new secret key should be larger than the number of bits of the previously stored secret key. N users share the new secret key. The j-th bits of the secret key clearly satisfy

$${\sum }_{i = 1}^{N} {\overline{k} }_{j}^{( i )} ≡ 0 ( mod 2 ) .$$

The controlling of the key replacement may allow each of the users to make the new authentication key string K′⁽ⁱ⁾=(k′₁⁽ⁱ⁾, k′₂⁽ⁱ⁾, . . . , k′ₙ⁽ⁱ⁾) by selecting the first n bits of K̅⁽ⁱ⁾=( k̅₁⁽ⁱ⁾, k̅₂⁽ⁱ⁾, . . . , k̅ₙ⁽ⁱ⁾, and replace the previously stored secret key with it.

The exemplary embodiment of the present invention may further include allowing the legitimate users to purify the transmitted quantum states including a portion of errors by various quantum error correction or distillation methods. For example, the well-known GHZ distillation protocol could be used, although it requires much advanced and unrealized quantum communication technologies.

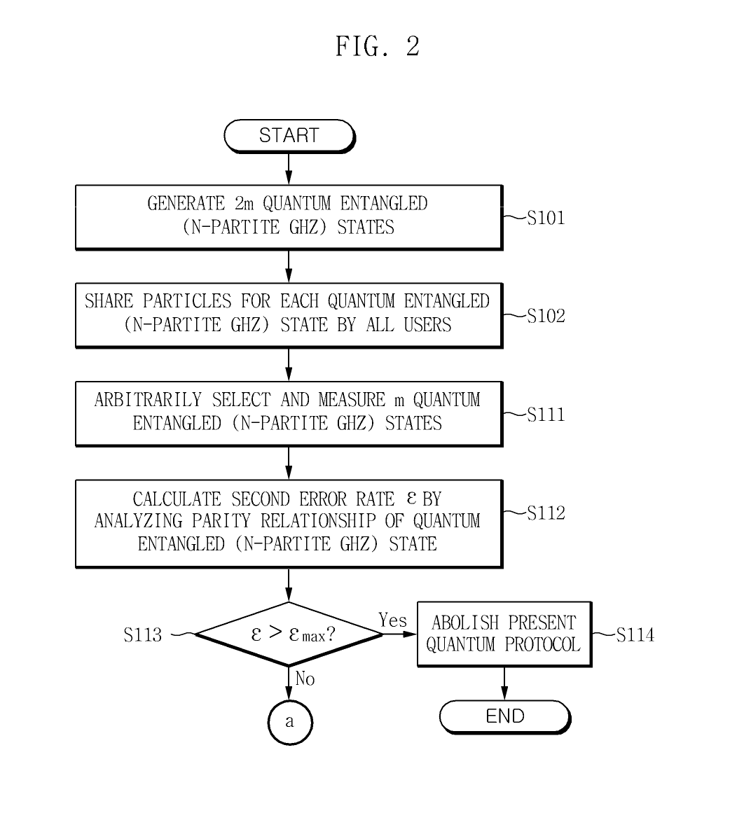

FIGS. 2 to 4 are flowcharts, in more detail, of a method for authenticating a user in a multiparty quantum communication according to an embodiment of the present invention. Hereinafter, duplicate parts with those of FIG. 1 will not be described.

First, referring to FIG. 2, the quantum communication server generates the quantum entangled (N-partite GHZ) states of the l (i.e. 2m) (S101). Thereafter, each particle of the l transmitted quantum entangled states is shared by all N users (S102). That is, steps S101 and S102 are included in the quantum transmission of the l quantum states of particles to N users at step S100 of FIG. 1.

Thereafter, the second error rate is measured (S110). Step S110 includes selecting m quantum entangled states randomly from the l quantum states of particles and measuring the each quantum state of the m quantum states on the X axis or the Y axis (S111).

Further, step S110 includes calculating the second error rate E by checking the parity relation between the measurement axis and the measurement value acquired by measuring the quantum states of the m particles (S112). When step S112 is performed, it is determined whether the second error rate is larger than a second error threshold value εₘₐₓ and when the second error rate is larger than the second error threshold value εₘₐₓ, a current quantum protocol is abolished (S114) and when the second error rate is not larger than the second error threshold value εₘₐₓ, the current quantum protocol is determined as a normal protocol to determine whether or not the disguised attacker is provided (S120).

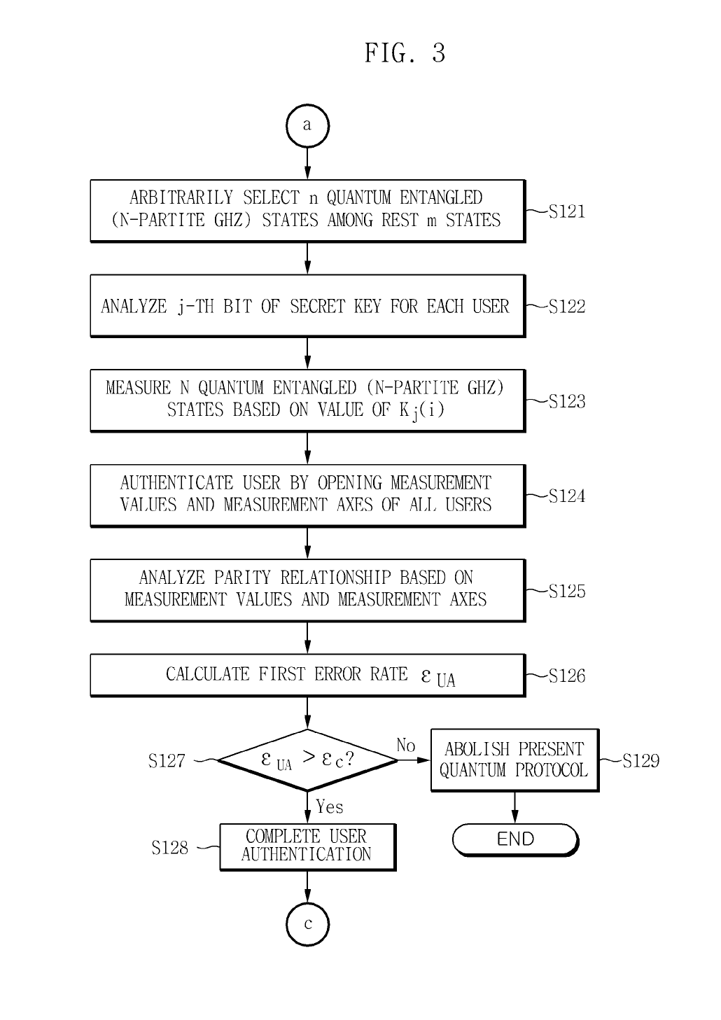

Referring to FIG. 3, authenticating the legitimate user by determining whether or not the disguised attacker is provided (S120) includes steps S121 to S129.

First, the n quantum states are randomly selected from the remaining m quantum states (S121). The particles of quantum states which are subjected to n quantum entangled states are measured based on the j-th value (Kⱼ⁽ⁱ⁾) of the previously stored secret key (S122).

In addition, the user authentication procedure begins with opening their measurement values and measurement axes (S123). Step S124 may be performed by analyzing the parity relation for the measurement values based on the measurement axes (S124). According to the result of the steps S123 and S124, the first error rate ε_{UA} is calculated (S125).

Thereafter, it is determined whether or not the first error rate ε_{UA} is larger than the first error threshold value ε_{c} (S126) and when the first error rate ε_{UA} is larger than the first error threshold value ε_{c}, the current quantum protocol is abolished by determining that the disguised attacker is provided in the current quantum protocol (S128). When the first error rate ε_{UA} is not larger than the first error threshold value ε_{c}, the user authentication passed successfully (S127).

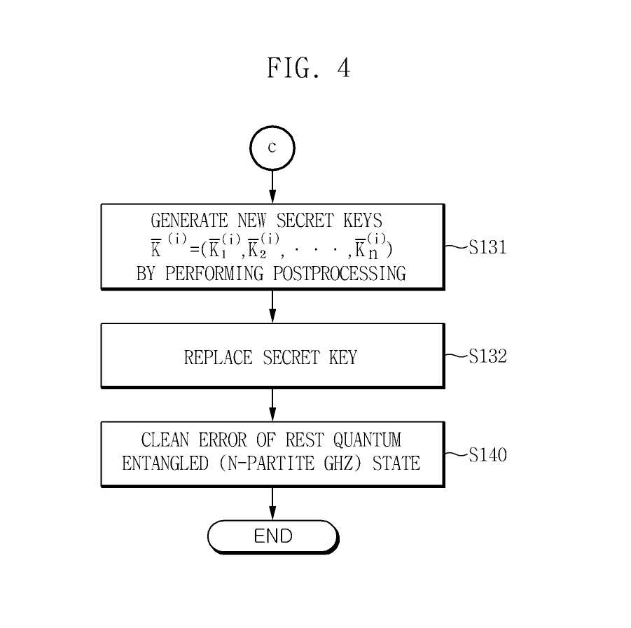

Referring to FIG. 4, after the user authentication is completed, each user generates a new secret key, that is, K̅⁽ⁱ⁾=( k̅₁⁽ⁱ⁾, k̅₂⁽ⁱ⁾, . . . , k̅ₙ⁽ⁱ⁾) by a series of post-processing (S131) and thereafter, replaces the previously stored secret key with a new generated secret key as an authentication key (S132).

Finally, by applying quantum error correction or distillation protocols to the rest quantum entangled states, each user obtains the pure quantum entangled states with no errors, which could be used to various quantum communication and cryptographic protocols (S140).

In the embodiment of the present invention described in the description of FIGS. 1 to 4, a plurality of users 200, 201, and 202 measures quantum states of particles possessed by themselves through the control by the quantum communication server 100. Further, the quantum communication server 100 generates the quantum entangled states and also calculates the first error rate and the second error rate by using measurement axes and measurement values that are measured by the users 200, 201, and 202.

However, in yet another embodiment of the present invention, the users 200, 201, and 202 will be able to perform the function while being connected to each other through quantum communication without the quantum communication server 100. That is, one user 200 serves as a server, that is, generates the quantum entangled state and transmits the generated quantum entangled state to other users 201 and 202. Each user transmits information on its own measurement value and measurement axis to the one user 200 to authenticate the user and calculate the error rate.

The new secret key is generated by each of the users 200, 201, and 202 in all the embodiments of the present invention. Since the new secret key is important for authenticating the user in the quantum communication, the new secret key should be accessed by only the users 200, 201, and 202. The quantum communication server 100 merely performs a function of controlling each of the users 200, 201, and 202 to generate the secret key.

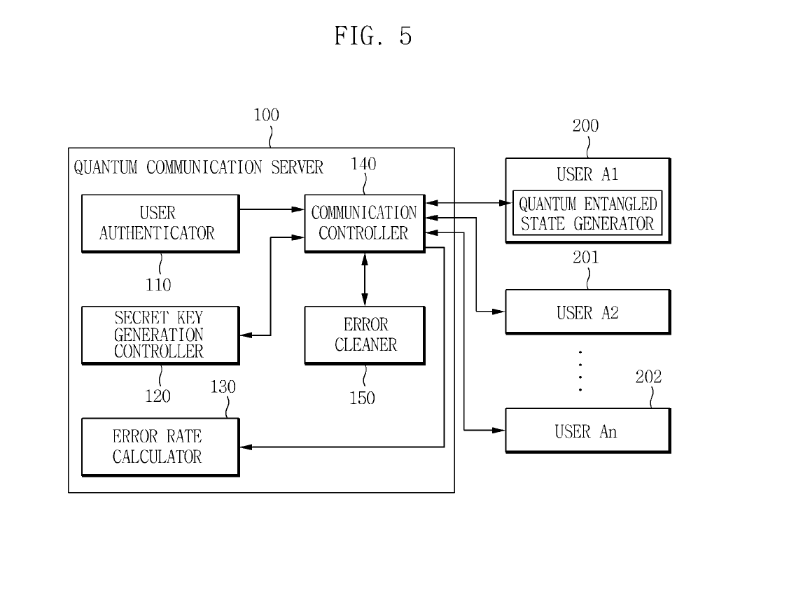

FIG. 5 is a block diagram of an apparatus for authenticating a user in a multiparty quantum communication according to an embodiment of the present invention.

Referring to FIG. 5, the apparatus for authenticating a user in a multiparty quantum communication according to the embodiment of the present invention comprises in the quantum communication server 100 which comprises a user authenticator 110, an error rate calculator 130, and a secret key generator 120. The apparatus may further include a quantum distiller 150. The quantum communication server 100 may further include a communication controller 140 for transmitting and receiving quantum and classical data. A plurality of users 200, 201, and 202 may be connected to the communication controller 140.

In the apparatus for authenticating a user in a multiparty quantum communication according to the embodiment of the present invention, the user authenticator 110 generates a command to allow one user among N (N is a natural number larger than 2) users to generate quantum entangled states with N particles and determines whether or not a disguised attacker is included in the N users.

That is, since the quantum entangled states with N particles should be generated as many as a l for authenticating the user, the user authenticator 110 may generate a command to allow a quantum generating device of the quantum communication server 100 or a quantum entangled state generator which may be possessed by any one user 200 among N users to generate the quantum entangled states with N particles as many as the first number.

Further, the user authenticator 110 may perform the function of determining whether or not the disguised attacker is included among N users through the plurality of steps described in the description of FIG. 1.

The error rate calculator 130 calculates the first error rate by using n quantum states randomly selected from quantum states of particles possessed by the users and a previously shared secret key in order to determine whether the disguised attacker is provided, and transmits the calculated first error rate to the user authenticator 110.

More specifically, the error rate calculator 130 calculates the first error rate by checking the parity relation between the measurement axes and the measurement values acquired by measuring n quantum states possessed by the users on the basis of the previously stored secret key.

The error rate calculator 130 may further include a function of calculating the second error rate as to whether or not the parity relation between the measurement axes and the measurement values given by performing the measurement on m quantum states arbitrarily selected from the l transmitted quantum states is satisfied in order to measure the rate of errors occurred during the transmission of the particles.

A third number is equal to or less than the rest number acquired by subtracting the n and the m from the l and equal to or more than the number of particles included in the previously stored secret key.

The secret key generator 120 controls the users to generate a new secret key by using mₖ quantum states arbitrarily selected from the quantum states on their own possession.

The secret key generator 120 may include a function of controlling a measurement value of any one of users to be converted according to the number of measurements with Y axis so that the measurement values on their possession always have the even parity relation.

In addition, each user divides the bit strings of the length mₖ, which consists of the measurement values, into a plurality of blocks, correct errors by comparing the parities of the block, and then obtains the key strings which have the even number parity. In order to amplify the privacy of the shared key strings, the secret key generator 120 may also include a function of reducing the length of key strings by a universal hashing based on a Toeplitz matrix.

N users 200, 201, and 202 replace the previously stored secret key with the newly received secret key.

According to the embodiment of the present invention, the apparatus may further comprise the quantum distiller 150 that provides a pure quantum entangled state distilled from the rest erroneous quantum entangled states by removing a part of them according to a specific rule. The purified quantum entangled states through the quantum distiller 150 will be able to be used for various quantum communication and cryptographic applications.

What is claimed is:

1. A method for authenticating a user in a multiparty quantum communication, comprising:
generating l quantum entangled states with N particles and transmitting each particle of the l quantum entangled states to N users, by a quantum communication server, wherein the N is a natural number larger than 2;
determining, by the quantum communication server, whether a disguised attacker exists among N users on the basis of a first error rate calculated by using n quantum states randomly selected from the l quantum states possessed by the users respectively and a previously shared secret key in each of the users; and
controlling, by the quantum communication server, each of the users to generate a new secret key using mₖ quantum states and replace the previously shared secret key with the new secret key.

2. The method of claim 1, wherein the determining calculates the first error rate by analyzing a parity relation between measurement axes and measurement values acquired by measuring n quantum states of particles possessed by each of the users respectively on the basis of the previously shared secret key.

3. The method of claim 2, wherein the measurement axes are determined as any one of an X axis and a Y axis depending on bit information of the previously shared secret key in the order of the quantum states to be measured.

4. The method of claim 2, wherein the determining abolishes a present quantum protocol by determining that the disguised attacker exists when the first error rate is larger than a threshold value of the first error rate.

5. The method of claim 2, wherein the first error rate is computed by selecting any one of an even parity relation and an odd parity relation depending on the number of the measurements with Y axis of each of the n quantum states, determining whether or not the parity relation selected is satisfied for each of the users, and using the determination result.

6. The method of claim 1, further comprising computing, by the quantum communication server, a second error rate related to whether or not measurement axes and measurement values acquired by measuring m quantum states of particles randomly selected from the l quantum states of particles satisfy a parity relation.

7. The method of claim 6, wherein the second error rate is computed by selecting any one of even parity relation and the odd parity relation depending on the number of the measurements measured with Y axis of each of the m quantum states, determining whether or not the parity relation selected is satisfied for each of the users, and using the determination result.

8. The method of claim 1, wherein the controlling comprises:
controlling, by the quantum communication server, each of the users to generate a new secret key; and
controlling, by the quantum communication server, each of the users to replace the previously stored secret key with the new secret key.

9. The method of claim 1, wherein the mₖ is equal to or less than the rest number acquired by subtracting n and m from l and equal to or more than the number of the particles included in the previously stored secret key.

10. The method of claim 8, wherein the controlling each of the users to generate controls each of the users to change a measurement value of a quantum state among the mₖ quantum states so that the parity relation of the mₖ quantum states is the even parity relation.

11. The method of claim 8, wherein the controlling each of the users to generate controls each of the users to divide bit string which is corresponding to mₖ quantum states into a plurality of blocks and generate bit string of the new secret key which has the length shortened to as many as the number of bits leaked during an error correction and h of bits relating to privacy amplification.

12. The method of claim 8, wherein the controlling each of the users to replace controls each of users to select an amount of bits required for the next authentication from the new secret key and replace the secret key previously stored.

13. The method of claim 6, further comprising purifing the error, by the quantum communication server, which occurs during the communications between users, of less than rest of the quantum states acquired by subtracting n, mₖ, and the m quantum states from the l quantum states.

14. An apparatus for authenticating a user in a multiparty quantum communication, comprising:
a user authenticator generating l quantum entangled states with N particles and determines whether or not a disguised attacker exists among the N users, wherein the N is a natural number larger than 2;
an error rate calculator calculating a first error rate by using n quantum states randomly selected from the l quantum states possessed by the users respectively and a previously shared secret key and providing the first error rate to the user authenticator in order to determine whether the disguised attacker exists; and
a secret key generation controller controlling each of the users to generate a new secret key using mₖ quantum states randomly selected from the l quantum states.

15. The apparatus of claim 14, wherein the error rate calculator calculates the first error rate by analyzing the parity relation between measurement axes and measurement values acquired by measuring n quantum states of particles possessed by the users respectively on the basis of the previously shared secret key.

16. The apparatus of claim 14, wherein the error rate calculator further comprises a function of computing a second error rate related to whether or not measurement axes and measurement values acquired by measuring m quantum states of particles randomly selected from the l quantum states of particles satisfy a parity relation.

17. The apparatus of claim 16, wherein the mₖ is equal to or less than the rest number acquired by subtracting the n and the m from the l and equal to or more than the number of particles included in the previously stored secret key.

18. The apparatus of claim 14, wherein the secret key generation controller comprise a function of controlling each of the user to change a measurement value of a quantum state among the mₖ quantum states so that the parity relation of the mₖ quantum states is the even parity relation.

19. The apparatus of claim 14, wherein the secret key generation controller controls each of the users divide bit string which is corresponding to mₖ quantum states into a plurality of blocks and generate bit string of the new secret key which has the length shortened to as many as the number of bits leaked during an error correction and h of bits relating to privacy amplification.

20. The apparatus of claim 16, further comprising a quantum distiller purifying an error, which occurs during the communications between users, of less than rest of the quantum states acquired by subtracting n, mₖ, and the m quantum states from the l quantum states.
